(19) United States
(12) Patent Application Publication
(10) Pub. No.: US 2011/0215588 A1
(43) Pub. Date: Sep. 8, 2011

(54) Linear hydraulic and generator coupling system and method

(76) Inventor: Ed Gilbert, JR., Dallas, GA (US)

(21) Appl. No.: 12/709,499

(22) Filed: Mar. 8, 2010

(51) Int. Cl. H02K 7/18; F03G 7/10

(52) U.S. Cl. 290/1 C; 74/DIG. 9

(57) ABSTRACT

The present invention consists of a generator or alternator coupled with a hydraulic cylinder/motor network. The coupling is achieved by a gear, rack and pinion system. Once the hydraulic cylinder/motor network is initiated by a battery, the output-shaft moves a rack in a linear motion while in contact with the pinion, which is mounted to the shaft of the generator/alternator, thus causing rotation of the generator/alternator shaft. As the generator/alternator shaft rotates, an electrical current is produced that can be used to supply a charge back to the battery and/or other articles which need a supply of electricity to operate, commercial or residential.

### BACKGROUND OF THE INVENTION

1. Field of the Invention

This invention relates generally to an electric hydraulic cylinder coupled with a generator/alternator. The hydraulic force is used to provide the necessary torque to initiate the generator/alternator.

2. Description of the related technology

Hydraulics is a system where an applied pressure is placed upon a fluid at one point of a contained unit. The pressure is transmitted to every part of the fluid and to the walls of the container. Since pressure is the force per unit area, the pressure will be expressed by the area of the container. In turn, the force is multiplied by the square of the radius of the container.

### SUMMARY OF THE INVENTION

The present invention provides a system and method for an electric-hydraulic coupling.

The invention has the ability to create an electrical charge after the system has been initiated. The hydraulic portion provides the amount of force necessary to satisfy the torque requirements of the alternator/generator being used.

### BRIEF DESCRIPTION OF DRAWINGS

FIG. 1 is a fragmentary cross-sectional view of the electric motor/hydraulic networks.

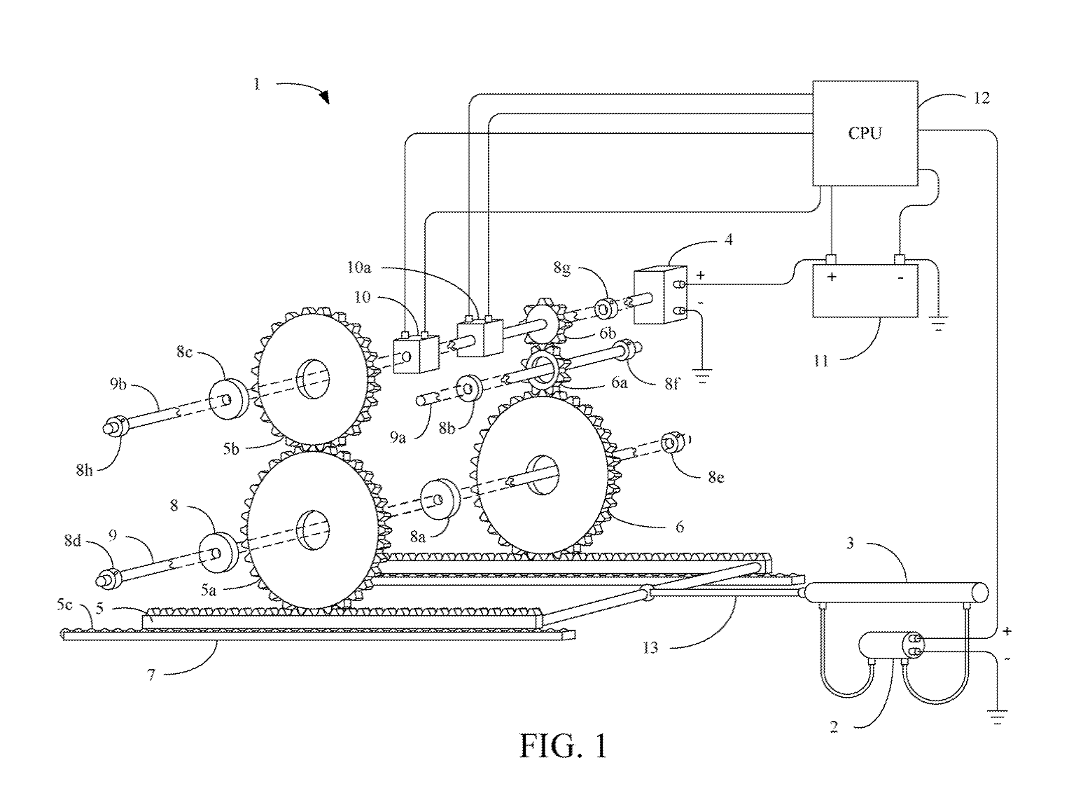

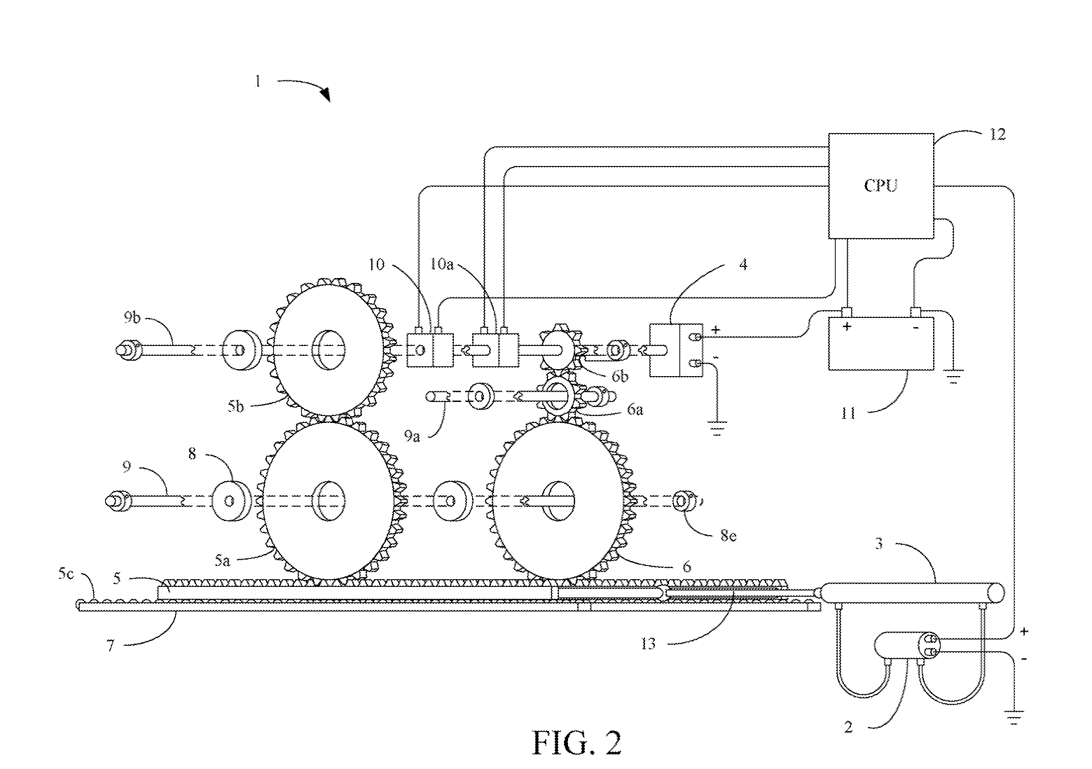

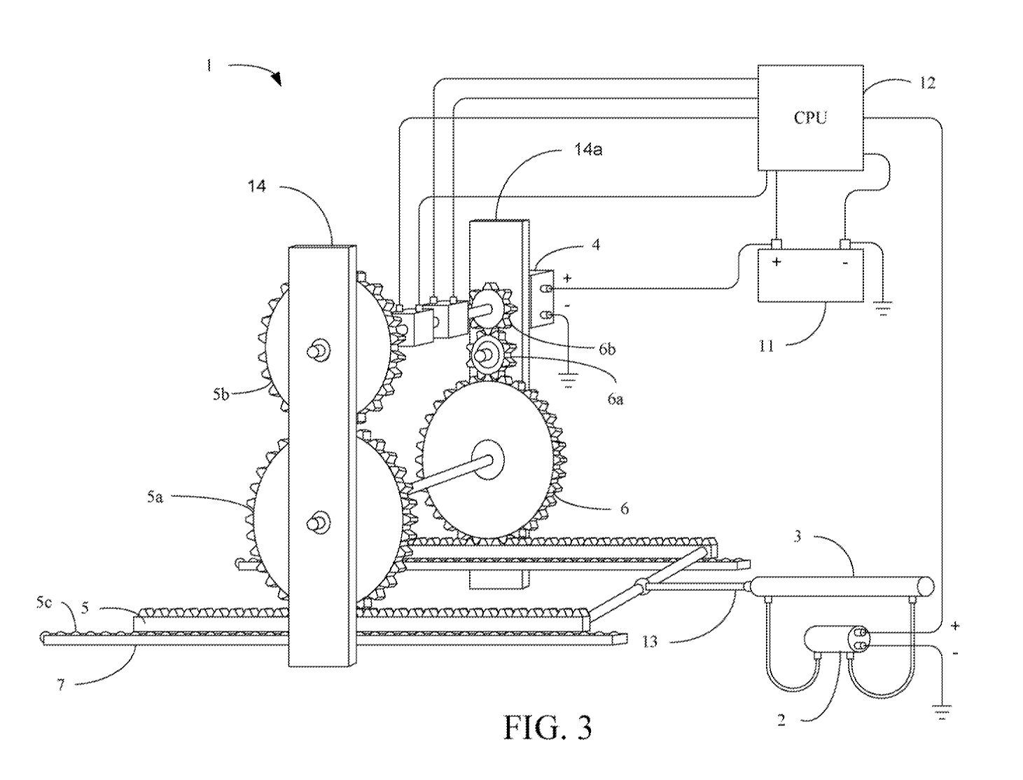

### DETAILED DESCRIPTION OF PREFERRED EMBODIMENT(S)

Referring now to the drawing, wherein like reference numerals designate corresponding structure throughout the view, a system and method 1 that is constructed according to a preferred embodiment of the invention includes a pump 2, hydraulic cylinder 3, an energy output producing device (ex. alternator/generator) 4, connecting gears 5a,5b, and 6, 6a, 6b, standard bearings 8, 8a, 8b,8c,8d,8e,8f,8g,8h and shafts 9,9a,9b,9c, rack 5, linear bearing system 5c, two support housings 14,14a, two electromagnetic clutch/brakes 10,10a attached thereto, an energy storage unit/source (ex. battery) 11, and a central processing unit (CPU) 12.

Once the CPU 12 closes the circuit, the energy storage unit/source (ex. battery) 11 energizes the pump 2 to carry fluid to the hydraulic cylinder 3; which causes the rack 5 to slide backwards or forward along a horizontal axis on a linear bearing network 5c; thus causing the pinion gears 5a, 6 to rotate simultaneously onto a bearing 8, 8a and a common shaft 9. As gear 5a rotates, it drives gear 5b onto a bearing 8c which drives shaft 9b to rotation. As gear 6 rotates, it drives gear 6a onto a bearing 8b and a shaft 9a, which in turn, drives gear 6b in opposite direction of shaft 9b. Shaft 9b is coupled with an electromagnetic clutch/brake 10 and shaft 9c. Shaft 9c is coupled with another electromagnetic clutch/brake 10a. The electromagnetic clutch/brake 10a is also coupled with the gear 6b and alternator/generator 4. While the rack is in horizontal forward or reverse motion, the CPU 12 keeps the electromagnetic clutch/brake 10 is in a holding position and the other electromagnetic clutch/brake 10a in an opened position or vice verse. The holding/closing system allows torque to be transferred to the alternator/generator 4; either by shaft 9b or gear 6b and to keep the same desired direction of rotation and speed. The same desired direction of rotation is achieved by allowing each drive unit to freewheel based on the direction of the rack 5 movement. When the rack 5 moves forward, torque (ex. clock-wise) is transferred from shaft 9b through the closed electromagnetic clutch/brake 10, to the opened electromagnetic clutch/brake 10a; which allows the drive gear 6b to freewheel and the torque is transferred through to the alternator/generator 4. As the rack 5 reverses, the CPU 12 opens electromagnetic clutch/brake 10 and closes electromagnetic clutch/brake 10a. Gear 5b will begin to freewheel in the opposite direction. Shaft 9b will no longer drive due to the engagement of the electromagnetic clutch/brake 10. Gear 6b is now the drive for the system as the electromagnetic clutch/brake 10a locks the gear into position. Due to the three gear 6,6a,6b configuration, the same direction is made possible as that of the two gear 5a,5b configuration. The switching between drives gears 5b,6b, allows the alternator/generator 4 to continuously rotate, in turn allowing the alternator/generator 4 produce applicable auxiliary electrical current and/or provide a charge throughout the electrical network of the system and method of.

Furthermore, the CPU 12 adjusts different parameters (ex. speed and electrical current) to compensate for any direct/indirect changes (ex. rack 5 direction, load, thermal) to keep a desired rotational speed and/or current from the electrical output producing device 4. Also, bearings 8d,8e,8f,8g,8h are mounted in a designated housing for structural support, as well as rotation. The end of the hydraulic shaft 13 is directly/indirectly attached to one end of the rack 5.

Even though numerous characteristics and advantages of the present invention have been set forth in the foregoing description, together with details of the structure and function of the invention, the disclosure is illustrative only, and changes may be made in detail, especially in the maters of shape, size and arrangement of parts within the principles of the invention to the full extent indicated by the broad general meaning of the terms in within the appended claims are expressed.

What I claim is:

1. System and method in which a current producing output device, such as a generator/alternator, is directly or indirectly (ex. pulleys, gears, flywheels, and levers) coupled to the output-shaft of a hydraulic cylinder/motor network.

2. The coupling mechanism in claim 1 consists of various drive systems.

3. The drive system in claim 1 consists of a rack and pinion set-up.

4. The coupling mechanism in claim 1 is attached to or part of the generator/alternator and/or hydraulic cylinder/motor network.

5. As the output-shaft in claim 1 slides a rack along a tract, the force of its liner motion is converted into torque which initiates the rotation of the generator/alternator, thus creating an electrical current.

6. The system and method in claim 1 utilizes various types of bearings (ex. freewheel, indexing), clutches (ex. mechanical, electromagnetic), and torque limiting devices to achieve a continuous or near continuous rotation of the system's final output-shaft: the final output-shaft being the portion which the current producing output producing device is connected.

7. Mechanical advantages such as gear reduction/increase, can be implemented into the system to increase overall efficiency of the system there of.

8. The hydraulic cylinder/motor network in claim 1 is energized by a stored unit/source of electrical DC current (battery) or AC current (household) to begin linear motion of the output-shaft.

9. The current producing output device (ex. alternator/generator) in claim 1 is directly or indirectly connected to the electrical storage source (ex. battery) in a manner in which an electrical current is transferred.

10. A current amplification, conditioning or manipulating device can be implemented within the system in claim 1 to increase the overall efficiency of the system there of.

11. Various hydraulic cylinder/motor networks can be configured to inter-connect in series, parallel, or mixed (series/parallel) to achieve a desired output-shaft force.

12. The system and method in claim 1 can be configured to inter-connect in series, parallel, or mixed (series/parallel) to achieve a desired electrical current.

13. In the system and method in claim 1 the hydraulic cylinder/motor network can be staged (ex. single or double); where as, the single-staged system consists of opposing hydraulic cylinders one attached at each end of the rack in a push/pull configuration. The double-staged system utilizes a single hydraulic cylinder capable of generating a force in both push and pull direction.

14. The current output producing device in claim 1 is capable of producing an electrical current by clockwise/counter-clockwise rotation.

15. The system and method in claim 1 can be coupled to any device which needs rotation to operate; with or without a charging unit.

16. An operating system consisting of mechanical switching and/or electronic control is utilized to control the overall operation of the system and method in claim 1.

17. The electronic control system in claim 15 consists of hardware and software engineered to achieve homeostasis and to optimize the overall efficiency of the system and method in claim 1.

18. The mechanical parts in claim 1 can be housed as a single unit or separate sub-units.

19. The system and method in claim 1 can be configured to be utilized in any article which uses a motor to operate.

20. A thermal control system may be implemented within the system and method in claim 1 utilizing various types of cooling methods.
